(19) United States
(12) Patent Application Publication
(10) Pub. No.: US 2013/0334215 A1
(43) Pub. Date: Dec. 19, 2013

(54) MICROWAVE HEATING APPARATUS WITH MULTI-FEEDING POINTS

(71) Applicant: Whirlpool Corporation, Benton Harbor, MI (US)

(72) Inventors: Juan Chen, Norrkoping (SE); Fredrik B. Hallgren, Norrkoping (SE)

(21) Appl. No.: 13/920,360

(22) Filed: Jun. 18, 2013

(30) Foreign Application Priority Data
Jun. 18, 2012 (EP) 12172392.8

(51) Int. Cl. H05B 6/64; H05B 6/68

(52) U.S. Cl. CPC H05B 6/6447; H05B 6/687
USPC 219/705; 219/702; 219/709

(57) ABSTRACT

A microwave heating apparatus and a method of heating a load using microwaves is disclosed. The microwave heating apparatus includes a cavity configured to receive a load, a microwave source for generating microwaves and a plurality of transmission lines for guiding the generated microwaves to the cavity. The microwave heating apparatus may also include an electronic device adapted to adjust the impedances of each of the plurality of transmission lines individually, a measuring device adapted to obtain a signal representative of the impedance of each one of the plurality of transmission lines, and a control unit configured to control the electronic device based on the obtained signals. The microwave heating apparatus, as disclosed, provides a microwave heating apparatus configured to heat a load with improved energy efficiency and improved heating evenness.

### TECHNICAL FIELD

The present invention relates to the field of microwave heating, and in particular to a method and a microwave heating apparatus for heating a load by means of microwaves.

### BACKGROUND

The art of microwave heating involves feeding of microwave power in a cavity. Conventionally, a microwave oven comprises a cooking chamber, or cavity, in which the load to be heated, such as a food item, is placed. A microwave oven also comprises a microwave source, usually a magnetron, a transmission line, and a feeding port for feeding the microwaves to the cavity.

When heating a load in the form of food by means of a microwave oven, there are a number of aspects which have to be considered. Most of these aspects are well-known to those skilled in the art and include, for instance, the desire to obtain uniform heating of the food at the same time as a maximum amount of available microwave power is absorbed in the food to achieve a satisfactory degree of efficiency.

In addition to different energy absorption coefficient in different parts of the food because of variation in food composition and geometry, uneven heating using microwave power may be due to the presence of hot and cold spots in the mode field used to heat the food, i.e. due to a non-uniform heating pattern in the cavity. Traditional solutions to eliminate, or reduce, the effect of hot and cold spots are the use of a turntable to rotate the load in the cavity of the microwave oven during heating or the use of a so-called “mode stirrer” to continuously alter the mode patterns within the cavity. Drawbacks of such techniques are that they are not fully satisfying in terms of heating uniformity and that they involve rotating or moving parts.

The heating efficiency may, in its turn, be limited by inadequate impedance matching between the feeding port and the cavity in which a load may be arranged. Traditional feeding systems of microwave ovens do not provide for any flexibility in impedance matching.

Thus, it would be desirable to provide a microwave heating apparatus and method for heating a load by means of microwaves with improved heating efficiency and also possibly improved heating uniformity.

### SUMMARY OF THE INVENTION

An object of at least some of the embodiments of the present invention is to wholly or partly overcome the above drawbacks of the prior art and to provide an improved alternative to traditional microwave heating apparatus.

Generally, it is an object of at least some of the embodiments of the present invention to provide a microwave heating apparatus capable of heating a load with improved heating evenness and improved energy efficiency.

This and other objects of the present invention are achieved by means of a microwave heating apparatus and a method having the features defined in the independent claims. Exemplary embodiments of the invention are characterized by the dependent claims.

Hence, according to a first aspect of the present invention, a microwave heating apparatus is provided. The microwave heating apparatus comprises a cavity arranged to receive a load, a microwave source for generating microwaves, a plurality of transmission lines for guiding, or feeding, the generated microwaves to the cavity, and an electronic device adapted to adjust the impedances of each of the plurality of transmission lines individually. The microwave heating apparatus further comprises a measuring device adapted to obtain a signal representative of the impedance of each one of the plurality of transmission lines, and a control unit configured to control the electronic unit based on the obtained signals.

According to a second aspect of the present invention, a method of heating a load arranged in a cavity via microwaves generated by a microwave source and guided to the cavity via a plurality of transmission lines is provided. The method comprises the steps of obtaining a signal representative of the impedance of each transmission line, and adjusting the impedances of each of some of the plurality of transmission lines based on the obtained signals.

The present invention makes use of an understanding that by feeding or guiding microwave energy from a microwave source to a cavity via a plurality of transmission lines, and adjusting the impedances of each of the plurality of transmission lines individually via an electronic device, the heating efficiency and uniformity of a microwave heating apparatus may be improved.

In the microwave heating apparatus of the present invention, the microwave power can be transferred to the cooking cavity via a plurality of transmission lines and feeding ports (or antennas), which is advantageous in that it provides flexibility in the feeding of the microwaves as compared with ovens having a single feeding port.

Each of the transmission lines and its associated feeding port may provide a specific mode field, i.e. a specific heating pattern in the cavity. The heating pattern resulting from feeding via a specific feeding port (or transmission line) may depend on e.g. the position (i.e. at which wall of the cavity) and the shape of the feeding port. The possibility of feeding microwaves to the cavity via a plurality of transmission lines or feeding ports is advantageous in that different mode fields may be combined (superposition of heating patterns) and/or that feeding may be realized by switching between different mode fields, depending on the desired heating pattern in the cavity. It is therefore possible to achieve a more uniform heating pattern.

It will also be appreciated that generally the number and/or type of available mode fields in the cavity are determined by the design of the cavity. The design of the cavity comprises the physical dimensions of the cavity and the location of the feeding ports in the cavity. The dimensions of the cavity are generally referred to as the height (distance between the bottom and the ceiling of the cavity), the depth (distance between the front door and the rear wall of the cavity) and the width (distance between the two lateral walls, from e.g. the wall located at the right handside to the wall located at the left handside). The feeding ports may be arranged at, in principle, any walls of the cavity. However, there is generally an optimized location of a feeding port for a predefined mode. For examples, the feeding ports may be located at a side wall, the bottom, the ceiling or the rear wall of the cavity.

Further, the heating efficiency may be improved by the electronic device that is adapted to adjust the impedances of one, several or each of the transmission lines, based on the signals representative of the impedances of each of the transmission lines, as obtained by the measuring device.

The present invention is thus advantageous in that it provides a microwave heating apparatus wherein the heating pattern may be adjusted, thereby enabling improvement of the heating uniformity, and, in addition, the heating efficiency may be improved by adjusting the impedances of the transmission lines.

As compared to prior art microwave ovens in which feeding is performed via a single feeding port with a static impedance matching, the present invention provides a microwave heating apparatus with the capability of dynamic impedance matching.

The measuring device (or unit) may be adapted to obtain a signal representative of the impedance experienced by the microwave source. The signal may be obtained by measuring the amplitude of the microwaves reflected towards the microwave source, and the amplitude of the microwaves input in the transmission lines from the microwave source. The impedance of a transmission line may be derived from such measurements.

In general, the efficiency may be defined as the relation between the power (or amplitude) of microwaves reflected from the cavity back towards the microwave source and the power (or amplitude) of microwaves being transmitted into the cavity (or supplied by the microwave source). The more dissipated power in the load, the less is the reflected power and the higher is the heating efficiency. By improving the impedance matching of a transmission line, less power is reflected back from the cavity, thereby increasing the dissipated power in the load and increasing the efficiency.

It will be appreciated that, due to cross-talk between the transmission lines, microwaves originally transmitted along a transmission line to the cavity may be transmitted towards the microwave source along another transmission line. The amplitude of microwaves transmitted towards the microwave source in a transmission line is therefore the contribution of its own reflection and the cross-talk.

The impedance can be measured for one, several or each of the transmission lines, individually. The overall impedance experienced by the microwave source is the result of the impedances of all transmission lines. The measuring device may e.g. be a directional coupler.

The present invention is advantageous in that it enables the impedance of each transmission line, individually, to be controlled. The impedance may then be adjusted to reduce the amplitude of reflected microwaves to a minimum, representing high energy efficiency.

According to an embodiment of the present invention, the microwave source may be a single solid state microwave generator. Solid state microwave generators are more flexible than magnetrons in that they are frequency-controllable, which advantageously allows for improved adjustment of heating patterns in the cavity and improved control of the output power of the generator.

Solid-state based microwave generators may, for instance, comprise silicon carbide (SiC) or gallium nitride (GaN) components. Other semiconductor components may also be adapted to constitute the microwave source. In addition to the possibility of controlling the frequency of the generated microwaves, the advantages of a solid-state based microwave generator comprise the possibility of controlling the output power level of the generator and an inherent narrow-band feature. The frequencies of the microwaves that are emitted from a solid-state based generator usually constitute a narrow range of frequencies such as 2.4 to 2.5 GHz. However, the present invention is not limited to such a range of frequencies and the solid-state based microwave source could be adapted to emit in a range centred at 915 MHz, for instance 875-955 MHz, or any other suitable range of frequency (or bandwidth). The embodiments described herein are for instance applicable for standard sources having mid-band frequencies of 915 MHz, 2450 MHz, 5800 MHz and 22.125 GHz.

According to an embodiment, the transmission lines may be microstrips, striplines, or other coaxial feeding means such as coaxial cables.

According to an embodiment, the microwave heating apparatus may further comprise an amplifier for amplifying the amplitude of microwaves generated by the microwave source and a power splitter for splitting the amplified microwaves to the plurality of transmission lines. The power splitter may be adapted to evenly split the microwaves into multiple outputs having equal amplitude and zero phase difference. The power splitter may also split the microwaves into other distributions having different amplitudes and phase differences, the control unit being in such case configured to control the heating, and in particular the selection of the transmission lines for feeding, based on such different distributions.

By amplifying the generated microwaves prior to splitting, a high output power from each transmission line can be ensured even though a single microwave source is used. Another advantage with using a single microwave source and splitting the generated microwaves into a plurality of transmission lines is that the production costs may be held down without limiting the feeding of the microwaves to only a single feeding port. In this way, a uniform heating may be provided at the same time as the cost of material can be reduced.

According to a further embodiment, the control unit may be configured to control the electronic device for impedance matching between each of the plurality of transmission lines and the cavity. The electronic device may for example comprise voltage tuneable dielectric capacitors or varactors (e.g. one capacitor per transmission line) and inductors, together forming an impedance matching network, such as a Pi-network, T-network, or L-network.

According to an embodiment, the control unit may be configured to operate on the basis of a time interval or on the basis of a time schedule including at least one time point.

The measurement may for example be performed at the beginning of an operation cycle, i.e. as the heating of the food is started, and optionally be followed by one or several further measurements during operation in order to compensate for changes of the conditions during the heating. Examples of such changes could be a variation of the temperature profile in the food item, the shape, the water content, and any other parameters affecting the impedance experienced by the microwave source.

The measurements may be performed periodically, i.e. on the basis of a certain time interval (such as e.g. every second) or according to a time schedule. Such time schedule may include one time point, such as at the start of the heating procedure, and may also include other time points not necessarily equally spaced in time. The microwave heating apparatus may e.g. comprise a storage means (or memory) with a lookup table in which a time schedule for operating the measuring device is associated with a particular cooking function or other parameters (such as the weight of the food item).

The measuring device may also operate on the basis of a time interval selected to be so short that it is equivalent to performing the measurements on a continuous basis, thereby improving the heating efficiency even further.

According to an embodiment, the control unit may be configured to select, for feeding the generated microwaves to the cavity, transmission lines among the plurality of transmission lines based on at least one of a desired heating pattern, a predetermined cooking function and information about the load. The control unit may then be configured to control the electronic device for impedance matching of the selected transmission lines.

Advantageously, depending on the design of the cavity which may support different modes or mode fields, the control unit may be configured to select transmission lines resulting in complementary heating patterns, thereby providing uniform heating in the cavity. The transmission lines used for feeding (via e.g. switching between transmission lines) may then provide complementary heating patterns such that the presence of hot and cold spots in a first heating pattern (or first mode) obtained via a first transmission line is compensated by a second heating pattern (or second mode) obtained via a second transmission line. In other words, the effect of hot and cold spots in a first mode field, i.e. the presence of hot and cold spots in the cavity, obtained by feeding via a first transmission line may be eliminated, or at least significantly reduced, by the heating pattern of a second mode field obtained by feeding via a second transmission line. As a result, a microwave heating apparatus with improved heating uniformity is provided. Similarly, the transmission lines may be selected such that undesired edge overheating (or burning) is suppressed, or at least significantly reduced.

As a mode may become distorted because of e.g. a change in the load (such as for example a change in geometry, weight or state), the control unit may be adapted to determine which of the transmission lines are suitable to provide a desired heating pattern based on a time interval or according to a time schedule, the measuring device performing measurements according to such time interval or time schedule and providing the results of the measurements to the control unit.

According to the present embodiment, the control unit may also be adapted to select the transmission lines providing the mode fields in accordance with a desired heating pattern (e.g. to improve heating uniformity), and the electronic device may be adapted to match the impedance of these selected transmission lines with the cavity (in which a load may be arranged) to ensure a high heating efficiency. Indeed, from knowledge of a desired heating pattern or information about the load, the control unit may select transmission lines via which such desired heating pattern may be obtained.

According to another embodiment, the control unit may be configured to select, for feeding the generated microwaves to the cavity, transmission lines among the plurality of transmission lines based on the signals obtained from the measuring device. The control unit may select one, several, or every transmission line.

The present embodiment is advantageous in that the control unit may select the transmission lines for which the impedance matching to the cavity (in which a load may be arranged) is optimum or at least satisfying. In other words, the control unit may select the transmission lines providing a satisfactory heating efficiency, thereby ensuring an improved overall heating efficiency of the microwave heating apparatus.

Alternatively, the control unit may be configured to select the transmission lines for which the impedance does not deviate by more than a predetermined percentage (like e.g. 20%) from an impedance target value. This alternative is advantageous in that any required adjustment of the impedance of a selected transmission line by the electronic device is facilitated. In other words, only the transmission lines for which an impedance target value is reachable may be selected.

The selection may for example be based on the amplitudes of microwaves reflected back towards the microwave source, the control unit being configured to select the transmission lines for which the amplitudes represent reflection minima or are below a threshold at an impedance target value (or target impedance). Optionally, the selection may also be based on other parameters such as for example a desired heating pattern in the cavity, a predetermined cooking function, or information about the load.

Thus, the control unit may be configured to identify the transmission lines providing the best impedance matching or providing impedance for suitable impedance matching and also the transmission lines providing the required mode fields, i.e. a desired heating pattern, as may be derived by the control unit based on a selected cooking function or any other information about the load (such as its weight, shape or composition).

According to yet another embodiment, the control unit may be adapted to regulate the sequence order for switching the feeding of microwaves between the selected transmission lines during an operation cycle and/or the duration of the feeding of microwaves via each of the selected transmission lines.

Such regulation may for instance be based on (or depend on) the desired heating pattern, a selected cooking function and other information about the load.

According to another embodiment, the measuring device may be adapted to, on the basis of a time interval, or on the basis of a time schedule including at least one time point, measure, for each of the plurality of transmission lines (or for the selected transmission lines), the amplitude of microwaves reflected back towards the microwave source as a function of the operating frequency of the microwave source. The measurements may then be used by the control unit, which is adapted to select a frequency of the generated microwaves. This is advantageous since the amplitude of microwaves reflected back towards the microwave source depends on the frequency of the microwaves for a particular state of the load. Thus, by comparing the results of the measurements performed for the various transmission lines at different frequencies, the control unit may then determine a frequency for which the best impedance matching may be obtained.

According to yet another embodiment, the control unit may be adapted to operate the microwave source at a frequency for which the amplitudes of reflected microwaves represent reflection minima or are below a threshold at an impedance target value for transmission lines selected for feeding.

In the present embodiment, the control unit may be configured to operate the microwave source at a frequency for which the amplitudes of reflected microwaves in each of the selected transmission lines are below a threshold (or represent minima), which corresponds to conditions of high heating efficiency. Such selection of the operating frequency may be performed with respect to an impedance target value.

According to a further embodiment, the control unit may be adapted to operate the microwave source at a frequency for which the amplitudes of reflected microwaves for transmission lines selected for feeding represent reflection minima or are below a threshold at an impedance target value, and to adjust the frequency based on a continuous basis, on the basis of a time interval, or on the basis of a time schedule including at least one time point.

The advantage of performing the impedance measurements as a function of the operating frequency on the basis of a time interval or according to a time schedule is the possibility to compensate for any changes in the load during the heating procedure, which changes may affect the selection of the optimal operating frequency.

According to yet a further embodiment, the control unit may be adapted to select, for feeding the generated microwaves to the cavity, the transmission lines for which the amplitudes of microwaves reflected back towards the microwave source represent reflection minima or are below a threshold at a target impedance value.

It will be appreciated that any of the features in the embodiments described above for the microwave heating apparatus according to the first aspect of the present invention may be combined with the method according to the second aspect of the present invention.

According to a third aspect of the present invention, there is provided a computer program product, loadable into a microwave oven, comprising software code portions for causing a processing means of the microwave oven to perform the method, for heating a load arranged in a cavity, as described above.

Further objectives of, features of, and advantages with, the present invention will become apparent when studying the following detailed disclosure, the drawings and the appended claims. Those skilled in the art will realize that different features of the present invention can be combined to create embodiments other than those described in the following.

### BRIEF DESCRIPTION OF THE DRAWINGS

The above, as well as additional objects, features and advantages of the present invention, will be better understood through the following illustrative and non-limiting detailed description of preferred embodiments of the present invention, with reference to the appended drawings, in which:

FIG. 1 schematically shows a microwave heating apparatus according to an embodiment of the present invention;

FIGS. 2a-2c schematically shows examples of impedance matching networks;

FIG. 3 is a block diagram schematically showing a microwave heating apparatus according to an embodiment of the present invention;

FIG. 4 illustrates the outline of a method for heating a load arranged in a cavity in accordance with an embodiment of the present invention.

All the figures are schematic, not necessarily to scale, and generally only show parts which are necessary in order to elucidate the invention, wherein other parts may be omitted or merely suggested.

### DETAILED DESCRIPTION

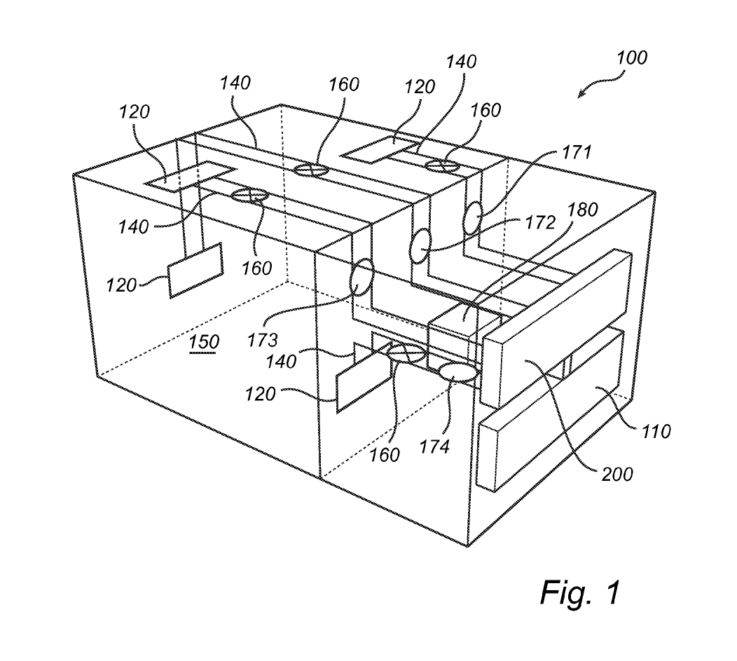

With reference to FIG. 1, there is shown a schematic view of a microwave heating apparatus according to an embodiment of the present invention.

The microwave heating apparatus 100 comprises a cavity 150 arranged to receive a load. The microwave heating apparatus 100 is equipped with a microwave source 110 for generating microwaves, and a plurality of transmission lines 140 for guiding the generated microwaves to the cavity 150.

The microwave heating apparatus 100 is also equipped with an electronic device 160 adapted to adjust the impedances of each of the plurality of transmission lines 140 individually, and a control unit 180 configured to control the electronic device 160 based on the obtained signals.

For generating the microwave power, the microwave heating apparatus 100 may be equipped with a microwave source 110 being a single solid state microwave generator capable of generating microwaves at a controllable frequency and output power level.

For guiding the generated microwaves to the cavity 150, the microwave heating apparatus 100 may also be equipped with transmission lines 140 including microstrips. The microstrips 140 may be arranged between the microwave source 110 and a feeding port 120 of the cavity 150, each one of the microstrips having a first end connected to the microwave generator and a second end connected to a dedicated feeding port 120.

A feeding port 120 may for instance be an antenna, such as a patch antenna or an H-loop antenna, or even an aperture in a wall (including sidewalls, the rear wall, the bottom, and the ceiling) of the cavity 150.

The cavity 150 of the microwave heating apparatus 100 defines an enclosing surface wherein one of the side walls of the cavity 150 may be equipped with a door (not shown in FIG. 1 but the door may suitably be arranged at the open side of the depicted cavity 150) for enabling the introduction of a load, e.g. a food item, in the cavity 150.

In general, the number and/or type of available mode fields in a cavity 150 are determined by the design of the cavity 150, the number of feeding ports 120 that are used, and the location of the feeding ports 120 in the cavity 150. The design of a cavity 150 comprises the physical dimensions of the cavity 150 which are generally provided by the height, depth and width.

The impedance mismatch created between any feeding port 120 and the cavity 150 is preferably tuned by adjusting the impedance of each of the plurality of transmission lines 140 by an electronic device 160 arranged in each of the transmission lines 140.

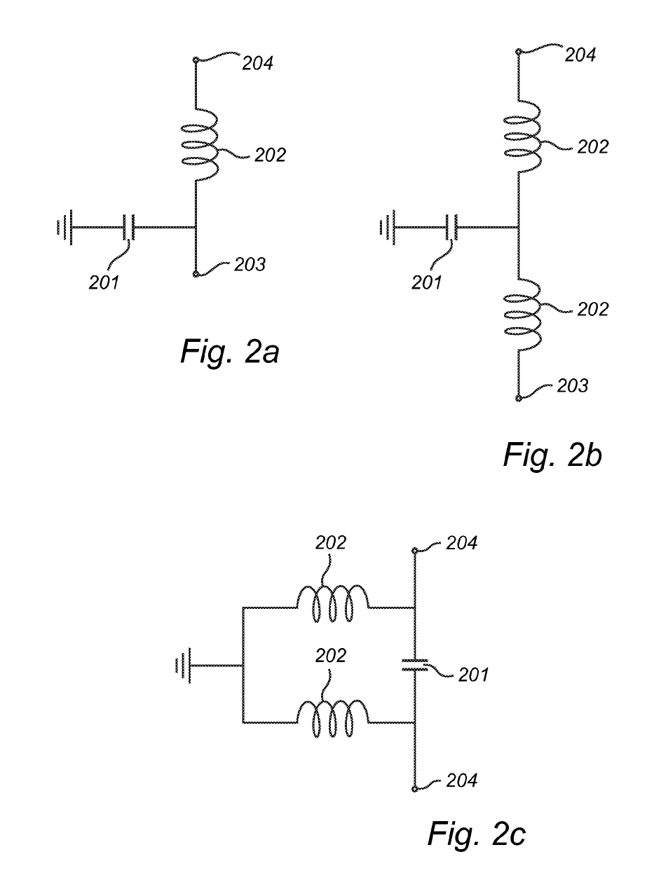

FIGS. 2a-c schematically shows three examples of impedance matching networks according to exemplifying embodiments. FIG. 2a shows an example of an L-network, having a capacitor 201 in parallel with the output 203 and an inductor in series between the input 204 and the output 203. FIG. 2b shows a T-network having two series inductors 202 and a parallel capacitor 201, and FIG. 2c shows a Pi-network having a series capacitor 201 and two parallel inductors 202.

According to one embodiment, the electronic device 160 may comprise voltage tuneable dielectric capacitors 201 for impedance matching in each of the transmission lines 140.

Still referring to FIG. 1, the microwave heating apparatus 100 may be equipped with a measuring device 171-174 for obtaining a signal representative of the impedance of each one of the plurality of transmission lines 140. The measuring device 171-174, such as a directional coupler (as described in EP10153670.4, the disclosure of which is incorporated herein by reference in particular with respect to the feature of the direction coupler) or a measuring device for measuring the complex impedance (such as described in EP12158106.0 by the same applicant, the disclosure of which is also incorporated herein by reference), may be arranged in each of the transmission lines 140 and adapted to measure an amplitude (or power) of microwaves reflected back towards the microwave source 110 for each of the plurality of transmission lines 140. From such measurements, the control unit 180 may derive an impedance value for each of the transmission lines 140. As an example, the measuring device 171-174 may measure the ratio between the amplitude of the power of the microwaves transmitted back towards the microwave source 110 and the amplitude of the power of microwaves supplied by the microwave source 110.

Further, the microwave heating apparatus 100 may include a control unit 180 for controlling the electronic device 160 based on the obtained signals. The control unit 180 may also be configured to select, for feeding the generated microwaves to the cavity 150, transmission lines 140 among the plurality of transmission lines 140. In addition, the control unit 180 may also be configured to operate the microwave source 110 at different frequencies. Preferably, the microwave source is frequency controllable.

In one embodiment, the microwave heating apparatus 100 comprises an amplifier 190 for amplifying the microwaves generated by the microwave source 110 and a power splitter 200 for splitting the amplified microwaves among the plurality of transmission lines 140. The amplifier 190 may be arranged between the transmission lines 140 and the microwave generator 110, or be incorporated in the microwave source 110 like in FIG. 1. The power splitter 200 may be arranged between the amplifier 190 and the transmission lines 140, and may be adapted to evenly split the amplified microwaves into e.g. four outputs having equal amplitudes and zero phase difference, such as shown in FIG. 1.

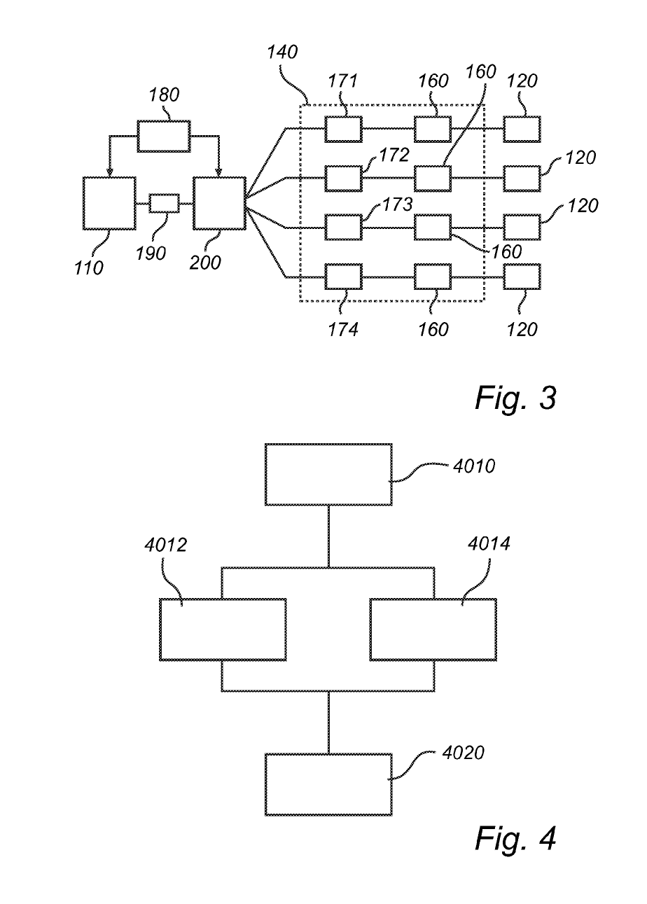

With reference to FIG. 3, there is shown a block diagram of a microwave heating apparatus 100 according to an embodiment of the present invention.

The single solid state microwave generator 110 generates microwaves that are amplified by the amplifier 190. The amplified microwaves may be evenly split by the power splitter 200 and guided into four transmission lines 140.

Each transmission line 140 comprises a measuring device 171-174 which may be adapted to operate on the basis of a time interval. In one example, the time interval may be chosen to be so short that it is equivalent to make measurements on a continuous basis. In another example, the measuring device 171-174 may be adapted to perform the measurements periodically, such as every second or every 5 seconds, during the operation cycle.

The measurements of the amplitude (or power) of microwaves reflected back towards the microwave source 110 may also be measured as a function of the operating frequency of the microwaves generated by the microwave source 110. It will be appreciated that, due to cross-talk between the transmission lines, microwaves originally transmitted along a transmission line to the cavity may be transmitted towards the microwave source along another transmission line.

Still referring to FIG. 3, the microwave heating apparatus 100 comprises a control unit 180 configured to select transmission lines 140 among the plurality of transmission lines 140 based on the signals obtained from the measuring device 171-174. Optionally, the selection may be based on a desired heating pattern in the cavity 150, a predetermined cooking function, and information about the load.

Alternatively, the control unit 180 may be configured to select the transmission lines 140 based on at least one of a desired heating pattern, a predetermined cooking function and information about the load, and to control the electronic device 160 for impedance matching of the selected transmission lines 140. For example, the control unit 180 may be configured to select transmission lines 140 resulting in complementary heating patterns. The transmission lines 140 used for switching may then provide complementary heating patterns such that the presence of hot and cold spots in a first heating pattern (or first mode) obtained via a first transmission line is compensated by a second heating pattern (or second mode) obtained via a second transmission line.

In one example, the control unit 180 is adapted to select the transmission lines 140 for which the amplitudes of microwaves reflected back towards the microwave source 110 represent reflection minima. In other examples the selected transmission lines 140 may represent an amplitude of reflected microwaves being below a threshold at an impedance target value.

According to one example, the control unit 180 is adapted to regulate the sequence order for switching the feeding of microwaves between the selected transmission lines 140.

Still referring to FIG. 3, each of the transmission lines 140 may be associated with a feeding port 120 arranged at a wall (including sidewalls, the rear wall, the bottom, and the ceiling) of the cavity 150. The feeding ports 120 are adapted to transmit the generated microwaves into the cavity 150.

Each transmission line 140 may also comprise an electronic device 160, such as an electronic impedance matching network (as e.g. described with reference to FIGS. 2a-c), being controlled by the control device 180. In one example the matching network is adapted to adjust the impedances of each of the transmission lines 140 based on a signal from the measuring device 171-174.

In another example the matching network may be adapted to adjust the impedances of a set of selected transmission lines 140, which set provides a mode field in accordance with a desired heating pattern, such that a high heating efficiency may be ensured.

FIG. 4 schematically shows a method of heating a load arranged in a cavity 150 via microwaves generated by a microwave source 110 and guided to the cavity 150 via e.g. four transmission lines 140. The method comprises a first step 4010 in which a signal representative of the impedance of each transmission line is obtained, and a second step 4020 wherein the impedances of each of some of the plurality of transmission lines 140 is adjusted based on the obtained signals.

In an embodiment, the method may also comprise a step 4012 of selecting, for feeding the generated microwaves to the cavity 150, transmission lines 140 among the plurality of transmission lines 140. This selection may be based on at least one of a desired heating pattern, a predetermined cooking function and information about the load and may e.g. be performed prior to the step of adjusting the impedances of the selected transmission lines 140. According to this embodiment, the impedance matching may be performed for the selected transmission lines 140.

According to another embodiment, the method may also comprise a step 4014 of selecting, for feeding the generated microwaves to the cavity, transmission lines 140 among the plurality of transmission lines 140 based on the obtained signals representative of the impedance of each transmission line. The impedance matching may be performed for the selected transmission lines 140.

The present invention is applicable for domestic appliances such as a microwave oven using microwaves for heating. The present invention is also applicable for larger industrial appliances found in e.g. food operation. The present invention is also applicable for vending machines or any other dedicated applicators.

While specific embodiments have been described, the skilled person will understand that various modifications and alterations are conceivable within the scope as defined in the appended claims.

I claim:

1. A microwave heating apparatus, comprising:
a cavity arranged to receive a load;
a microwave source configured to generate a plurality of microwaves;
a plurality of transmission lines configured to guide the generated microwaves to the cavity;
a measuring device adapted to obtain at least one signal representative of the impedance of each one of the plurality of transmission lines;
an electronic device adapted to adjust the impedances of each of the plurality of transmission lines individually; and
a control unit configured to control the electronic device based on the obtained signals.

2. The microwave heating apparatus according to claim 1, wherein the microwave source is a single solid state microwave generator.

3. The microwave heating apparatus according to claim 1, wherein the transmission lines include at least one of a microstrip, a stripline, and a coaxial feeding means.

4. The microwave heating apparatus according to claim 1, further comprising an amplifier configured to amplify the amplitude of microwaves generated by the microwave source and a power splitter configured to split the amplified microwaves to the plurality of transmission lines.

5. The microwave heating apparatus according to claim 1, wherein the electronic device includes at least one voltage tuneable dielectric capacitor for impedance matching in each of the transmission lines.

6. The microwave heating apparatus according to claim 1, wherein the control unit is configured to control the electronic device for impedance matching of at least one of the plurality of transmission lines.

7. The microwave heating apparatus according to claim 1, wherein the measuring device is configured to operate on the basis of a time interval or on the basis of a time schedule including at least one time point.

8. The microwave heating apparatus according to claim 1, wherein the control unit is configured to select, for feeding the generated microwaves to the cavity, transmission lines among the plurality of transmission lines based on at least one of a desired heating pattern, a predetermined cooking function and information about the load, and wherein the control unit is configured to control the electronic device for impedance matching of said selected transmission lines.

9. The microwave heating apparatus according claim 1, wherein the control unit is configured to select, for feeding the generated microwaves to the cavity, transmission lines among the plurality of transmission lines based on the obtained signals, and optionally based on at least one of a desired heating pattern in the cavity, a predetermined cooking function, and information about the load.

10. The microwave heating apparatus according to claim 8, wherein the control unit is further adapted to regulate the sequence order for switching the feeding of microwaves between the selected transmission lines during at least one of an operation cycle and the duration of the feeding of microwaves via each of the selected transmission lines.

11. The microwave heating apparatus according to claim 1, wherein the measuring device is adapted to measure an amplitude of microwaves reflected back towards the microwave source for each of the plurality of transmission lines for deriving an impedance value.

12. The microwave heating apparatus according to claim 1, wherein the measuring device is adapted to, on the basis of a time interval, or on the basis of a time schedule including at least one time point, measure, for each of the plurality of transmission lines, an amplitude of microwaves reflected back towards the microwave source as a function of the operating frequency of the microwave source, the control unit being adapted to select a frequency of the microwaves generated by the microwave source based on the measurements of the measuring device.

13. The microwave heating apparatus according to claim 12, wherein the control unit is adapted to operate the microwave source at a frequency for which the amplitudes of reflected microwaves represent reflection minima, or are below a threshold at an impedance target value for transmission lines selected for feeding.

14. The microwave heating apparatus according to claim 1, wherein the control unit is adapted to select, for feeding microwaves to the cavity, the transmission lines for which the amplitudes of microwaves reflected back towards the microwave source represent reflection minima, or are below a threshold at an impedance target value.

15. A method for heating a load arranged in a cavity via microwaves generated by a microwave source and guided to the cavity via a plurality of transmission lines, the method comprising:
obtaining a signal representative of the impedance of each transmission line; and
adjusting the impedances of at least one of the plurality of transmission lines based on the obtained signals.

16. The method according to claim 15, further comprising the step of
selecting, for feeding the generated microwaves to the cavity, transmission lines among the plurality of transmission lines based on at least one of a desired heating pattern, a predetermined cooking function and information about the load, wherein the step of adjusting the impedances is performed for the selected transmission lines.

17. The method according to claim 15, further comprising the step of selecting, for feeding the generated microwaves to the cavity, transmission lines based on the obtained signals representative of the impedance of each transmission line, wherein the step of adjusting the impedances is performed for the selected transmission lines.

18. (canceled)
